(19) United States
(12) Patent Application Publication
(10) Pub. No.: US 2026/0091653 A1
(43) Pub. Date: Apr. 2, 2026

(54) VEHICLE-MOUNTED AIR COMPONENT ADJUSTING SYSTEM

(71) Applicant: NGK INSULATORS, LTD., Nagoya-City (JP)

(72) Inventor: Takafumi HAMADA, Nagoya-Shi (JP)

(73) Assignee: NGK INSULATORS, LTD., Nagoya-City (JP)

(21) Appl. No.: 19/238,703

(22) Filed: Jun. 16, 2025

(30) Foreign Application Priority Data
Sep. 27, 2024 (JP) 2024-169318

(51) Int. Cl. B60H 3/06; B01D 53/04; B01J 20/18; B01J 20/28; B60H 3/02

(52) U.S. Cl. CPC B60H 3/0633; B01D 53/0438; B01J 20/18; B01J 20/28045; B60H 3/024; B01D 2253/108; B01D 2253/3425; B01D 2257/504; B01D 2257/80; B01D 2258/06; B01D 2259/40096; B01D 2259/4566; B60H 2003/028; B60H 2003/0691

(57) ABSTRACT

A vehicle-mounted air component adjusting system 1 includes: a conditioning device having an adsorption portion and a heating means; a duct 3 including the conditioning device therein and allowing the air to flow therethrough, the duct 3 having a vehicle interior flow path 30 for introducing the air that has passed through the conditioning device into the vehicle interior, and a vehicle exterior flow path 31 for discharging the air that has passed through the conditioning device to the vehicle exterior, and wherein, when an outlet of the vehicle exterior flow path 31 is viewed along an extending direction 31E of the vehicle exterior flow path 31 from an upstream side in a flow direction of the air 10, the outlet of the vehicle exterior flow path 31 is provided at a position displaced from an intake port 110 for the vehicle-mounted air conditioning system 11.

### FIELD OF THE INVENTION

The present invention relates to a vehicle-mounted air component adjusting system.

### BACKGROUND OF THE INVENTION

In various types of vehicles such as automobiles, there are increasing requirements for improvement of vehicle interior environment. Specific requirements illustrate reduction of an amount of carbon dioxide in the vehicle interior to suppress driver's drowsiness, control of humidity in the vehicle interior, and removal of harmful volatile components such as odor components and allergy-causing components in the vehicle interior. The effective measure for such requirements includes ventilation, but the ventilation causes a large loss of heater energy in winter, leading to a decreased energy efficiency in winter. In particular, a battery electric vehicle (BEV) has a problem that its cruising range is significantly reduced due to its energy loss.

Therefore, Patent Literature 1 proposes a vehicle-mounted air component adjusting system (vehicle air purifying system) including: a first flow path and a second flow path that are in communication with a vehicle interior; and an adsorption block located in each flow path. The adsorption block uses an adsorption material (zeolite) that can adsorb carbon dioxide and water vapor contained in air as adsorption target substances (purification target substances) and desorb the adsorption target substances when heated air passes through it. The first flow path and the second flow path branch downstream of the adsorption block into a flow path that is in communication with the vehicle interior and a flow path that is in communication with the outside of the vehicle interior, and a valve (switching mechanism) is provided in one of these flow paths to switch the flow of the air. According to the vehicle-mounted air component adjusting system, it is possible to achieve simultaneously an operation in which one adsorption block adsorbs the adsorbent target substances and returns the purified air to the vehicle interior, and an operation in which the other adsorption block can exhaust the air that has desorbed the adsorption target substances to the outside of the vehicle interior, and also prevent unpurified air from flowing into the vehicle interior.

### CITATION LIST

### Patent Literatures

[Patent Literature 1] Japanese Patent Application Publication No. 2020-104774 A

### SUMMARY OF THE INVENTION

Vehicles are equipped with vehicle-mounted air conditioning systems (HVAC systems) that provide heating (Heating), ventilation (Ventilation) and air conditioning (Air Conditioning). The vehicle-mounted air component adjusting system, such as that described in Patent Literature 1, may be located on an upstream side of the vehicle-mounted air conditioning system in a flow direction of air. Patent Literature 1 does not consider any positional relationship between the vehicle-mounted air conditioning system and the vehicle-mounted air component adjusting system, and depending on the positional relationship, there is a risk that the adsorption target substances desorbed from the conditioning device of the vehicle-mounted air component adjusting system may be introduced into the vehicle interior through the vehicle-mounted air conditioning system.

This invention has been made to solve the above problems, and one of objects thereof is to provide a vehicle-mounted air component adjusting system, which can reduce the risk that adsorption target substances desorbed from the conditioning device are introduced into the vehicle interior through the vehicle-mounted air conditioning system.

<1> In an embodiment, this invention relates to a vehicle-mounted air component adjusting system provided on an upstream side of a vehicle-mounted air conditioning system in a flow direction of air from a vehicle interior or a vehicle exterior to adjust components of the air, wherein the vehicle-mounted air component adjusting system comprises: a conditioning device having an adsorption portion containing an adsorbent configured to adsorb at least one adsorption target substance at a temperature lower than or equal to a predetermined temperature and to desorb the adsorbed adsorption target substance when the temperature exceeds the predetermined temperature, and a heating means configured to heat the adsorption portion; a duct comprising the conditioning device therein and allowing the air to flow therethrough, the duct having a vehicle interior flow path for introducing the air that has passed through the conditioning device into the vehicle interior, and a vehicle exterior flow path for discharging the air that has passed through the conditioning device to the vehicle exterior, and wherein, when an outlet of the vehicle exterior flow path is viewed along an extending direction of the vehicle exterior flow path from an upstream side in a flow direction of the air, the outlet of the vehicle exterior flow path is provided at a position displaced from an intake port for the vehicle-mounted air conditioning system.
<2> This invention may relate to the vehicle-mounted air component adjusting system according to <1>, wherein the intake port is an intake port for an interior air of the vehicle-mounted air conditioning system into which the air from the vehicle interior is introduced.
<3> This invention may relate to the vehicle-mounted air composition adjusting system according to <1> or <2>, wherein, when the outlet of the vehicle exterior flow path is viewed along the extending direction of the vehicle exterior flow path from the upstream side in the flow direction of the air, a ratio (A1/A0) of an area (A1) of a region that overlaps with the intake port at the outlet to a total area (A0) of the outlet is 30% or less.
<4> This invention may relate to the vehicle-mounted air component adjusting system according to any one of <1> to <3>, wherein the adsorption portion comprises: a structure having an outer wall and partition walls provided on an inner side of the outer wall, the partition walls defining flow paths for the air, each of the flow paths extending from a first end face to a second end face of the structure; and an adsorbing layer containing the adsorbent provided on a surface of each of the partition walls.
<5> The invention may relate to the vehicle-mounted air component adjusting system according to <4>, wherein the heating means has a pair of electrodes connected to the structure, and the structure is heated by applying an electric current through the pair of electrodes.
<6> This invention may relate to the vehicle-mounted air component adjusting system according to <5>, wherein at least the partition walls of the structure is made of a material having a PTC property.
<7> This invention may relate to the vehicle-mounted air component adjusting system according to <4>, wherein the heating means has a pipe provided inside the structure, and the structure is heated by a heated medium flowing through the pipe.
<8> This invention may relate to the vehicle-mounted air component adjusting system according to <4>, wherein the heating means has a heater for feeding heated air to the structure, and the structure is heated by allowing the heated air to flow through the structure.

According to an embodiment of the vehicle-mounted air component adjusting system, when the outlet of the vehicle exterior flow path is viewed along the extending direction of the vehicle exterior flow path, the outlet of the vehicle exterior flow path is provided at a position displaced from the intake of the vehicle-mounted air conditioning system, which can reduces the risk that the adsorption target substance desorbed from the conditioning device is introduced into the vehicle interior through the vehicle-mounted air conditioning system.

### BRIEF DESCRIPTION OF THE DRAWINGS

FIG. 1 is a block view illustrating a vehicle-mounted air component adjusting system according to an embodiment of this invention;

FIG. 2 is a schematic view illustrating the vehicle-mounted air component adjusting system in FIG. 1;

FIG. 3 is a schematic perspective view illustrating a first embodiment of a positional relationship between an outlet of a vehicle exterior flow path and an intake port of a vehicle-mounted air conditioning system in FIG. 2;

FIG. 4 is a front view illustrating the outlet of the vehicle exterior flow path in FIG. 3 and the intake port of the vehicle air conditioning system when viewed from the upstream side in the flow direction of the air along the extending direction of the vehicle exterior flow path;

FIG. 5 is a schematic perspective view illustrating a second embodiment of a positional relationship between an outlet of a vehicle exterior flow path and an intake port of a vehicle-mounted air conditioning system in FIG. 2;

FIG. 6 is a schematic perspective view illustrating a third embodiment of a positional relationship between an outlet of a vehicle exterior flow path and an intake port of a vehicle-mounted air conditioning system in FIG. 2;

FIG. 7 is a schematic perspective view illustrating a fourth embodiment of a positional relationship between an outlet of a vehicle exterior flow path and an intake port of a vehicle-mounted air conditioning system in FIG. 2;

FIG. 8 is a schematic perspective view illustrating a fifth embodiment of a positional relationship between an outlet of a vehicle exterior flow path and an intake port of a vehicle-mounted air conditioning system in FIG. 2;

FIG. 9 is an exploded perspective view of a duct, an intake port frame, and an intake port duct in FIG. 8;

FIG. 10 is a front view of a first embodiment of a conditioning device in FIG. 2;

FIG. 11 is a right side view of a conditioning device in FIG. 10;

FIG. 12 is an enlarged view illustrating a region XII in FIG. 10;

FIG. 13 is a perspective view of a second embodiment of a conditioning device in FIG. 2; and

FIG. 14 is a perspective view of a third embodiment of a conditioning device in FIG. 2.

### DETAILED DESCRIPTION OF THE INVENTION

Hereinafter, embodiments of the invention will be specifically described with reference to the drawings. The invention is not limited to each embodiment, and components can be modified and embodied without departing from the spirit of the invention. Further, various inventions can be formed by appropriately combining a plurality of components disclosed in each embodiment. For example, some components may be removed from all of the components shown in the embodiments. Furthermore, the components of different embodiments may be optionally combined.

### (1. Regarding Vehicle-Mounted Air Component Adjusting System)

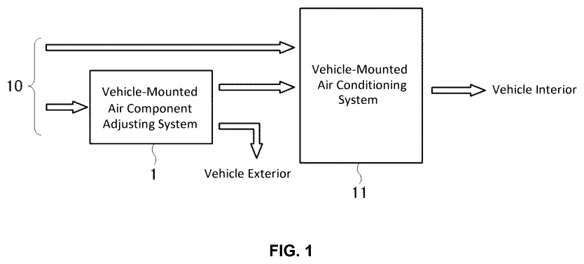

FIG. 1 is a block view illustrating a vehicle-mounted air component adjusting system 1 according to an embodiment of this invention. The vehicle-mounted air component adjusting system 1 is mounted on a vehicle and located on an upstream side of a vehicle-mounted air conditioning system 11 in a flow direction of air 10.

The vehicle includes, but not limited to, automobiles and electric rail cars. Non-limiting examples of the automobile include a gasoline vehicle, a diesel vehicle, a gas fuel vehicle using CNG (compressed natural gas) or LNG (liquefied natural gas), a fuel cell vehicle, an electric vehicle, and a plug-in hybrid vehicle. In particular, the vehicle-mounted air adjusting system according to an embodiment can be suitably used for a vehicle that has no internal combustion engine such as electric vehicles and electric rail cars.

The vehicle-mounted air conditioning system 11 provides heating, ventilation, and air conditioning in a vehicle and may be referred to as an HVAC system. The vehicle-mounted air conditioning system 11 feeds the air 10 from the vehicle interior or vehicle exterior to the vehicle interior. The air 10 that has passed through the vehicle-mounted air component adjusting system 1 and/or the air 10 that does not pass through the vehicle-mounted air component adjusting system 1 can be fed to the vehicle-mounted air conditioning system 11. The air 10 that passes through the vehicle-mounted air component adjusting system 1 may not be feed to the vehicle-mounted air conditioning system 11 and may be discharged to the vehicle exterior.

The vehicle-mounted air component adjusting system 1 is a system that adjusts components of the air 10. The vehicle-mounted air component adjusting system 1 can adjust the components of the air 10 by adsorbing and removing adsorption target substances in the air 10. The adsorption target substances can include, for example, moisture, carbon dioxide, and volatile components.

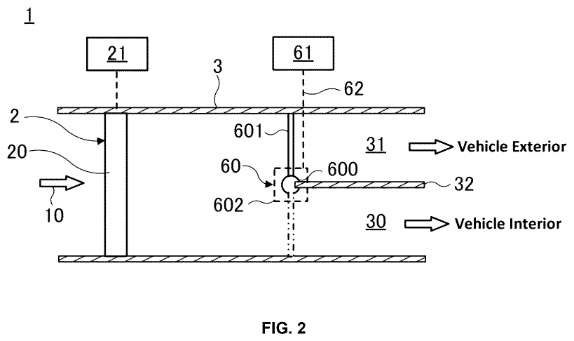

Next, FIG. 2 is a schematic view illustrating the vehicle-mounted air component adjusting system 1 in FIG. 1. As illustrated in FIG. 2, the vehicle-mounted air adjusting system 1 according to an embodiment of the invention includes a conditioning device 2 and a duct 3.

The conditioning device 2 has an adsorption portion 20 and a heating means 21. The adsorption portion 20 contains an adsorbent capable of adsorbing absorbent target substances at a temperature lower than or equal to a predetermined temperature and desorbing the adsorbent target substances when the temperature exceeds the predetermined temperature. The heating means 21 is configured to heat the adsorption portion 20. Heating of the adsorption portion 20 by the heating means 21 desorbs the adsorption target substances from the adsorbent in the adsorption portion 20.

The duct 3 has the conditioning device 2 provided therein and can allow the air 10 from the vehicle interior or the vehicle exterior to flow therethrough. The duct 3 has a vehicle interior flow path 30 through which the air 10 that has passed through the conditioning device 2 flows into the vehicle interior, and a vehicle exterior flow path 31 through which the air 10 that has passed through the conditioning device 2 is discharged to the vehicle exterior. The vehicle interior flow path 30 and the vehicle exterior flow path 31 are separated from each other by a duct partition wall 32. Although not shown, the vehicle interior flow path 30 and the vehicle exterior flow path 31 may be provided at a distance from each other.

The vehicle-mounted air component adjusting system 1 can have a switching valve 60 that can switch the flow of the air 10 flowing through the duct 3 between the vehicle interior flow path 30 and the vehicle interior flow path 30. The switching valve 60 can cause the air 10 to flow into the vehicle interior flow path 30 when the adsorption target substances in the air 10 are adsorbed into the conditioning device 2, and can cause the air 10 to flow into the vehicle exterior flow path 31 when the adsorption target substances are desorbed from the conditioning device 2. FIG. 2 shows the air 10 being allowed to flow into the vehicle interior flow path 30. It is intended that the air 10 flowing through the vehicle interior flow path 30 is fed to the vehicle air conditioning system 11, and the air 10 flowing through the vehicle exterior flow path 31 is discharged to the vehicle exterior without being fed to the vehicle-mounted air conditioning system 11.

The switching of the switching valve 60 can be performed, for example, by electrically connecting the control unit 61 to the switching valve 60 by the electric wire 62 or wirelessly, and operating a switch (not shown) of the switching valve 60 by the control unit 61. The switching valve 60 is not particularly limited as long as it is a valve that is electrically driven and has the function of switching the flow path, and includes electromagnetic valves and electric valves. In an embodiment, the switching valve 60 includes an opening/closing door 601 supported by a rotating shaft 600 and an actuator 602 such as a motor that rotates the rotating shaft 600. The actuator 602 is configured to be controllable by the control unit 61.

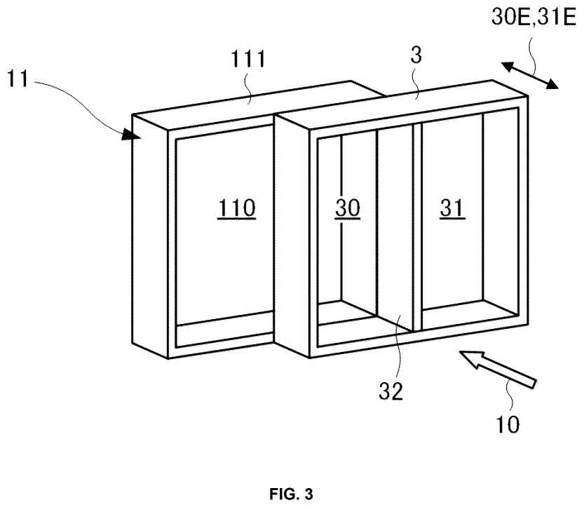

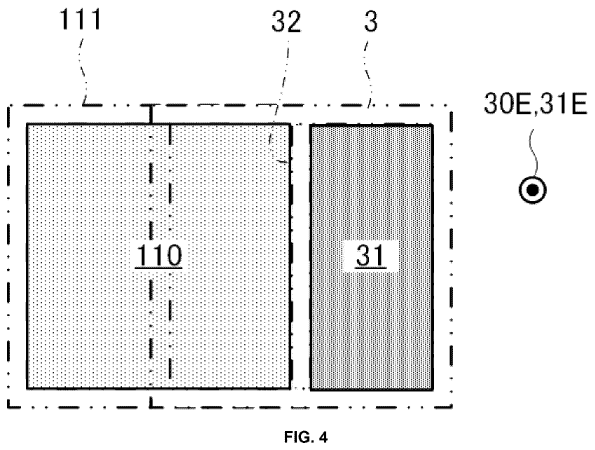

Next, FIG. 3 is a schematic perspective view illustrating a first embodiment of a positional relationship between an outlet of the vehicle exterior flow path 31 and an intake port 110 of the vehicle-mounted air conditioning system 11 in FIG. 2, and FIG. 4 is a front view illustrating the outlet of the vehicle exterior flow path 31 in FIG. 3 and the intake port 110 of the vehicle air conditioning system 11 when viewed from the upstream side in the flow direction of the air 10 along an extending direction 31E of the vehicle exterior flow path 31. In FIG. 4, for ease of viewing, the wall of the duct 3, which define the vehicle interior flow path 30 and the outlet of the vehicle exterior flow path 31, and the wall of the intake port frame 111, which defines the intake port 110, are depicted with two dotted lines, and the vehicle interior flow path 30 is omitted.

In the vehicle-mounted air component adjusting system 1 according this embodiment, when the outlet of the vehicle exterior flow path 31 is viewed from the upstream side in the flow direction of the air 10 along the extending direction 31E of the vehicle exterior flow path 31, the outlet of the vehicle exterior flow path 31 is provided at a position displaced from the intake port 110 of the vehicle-mounted air conditioning system 11. When desorbing the adsorption target substances from the conditioning device 2, as described above, the air 10 is allowed to flow into the vehicle exterior flow path 31. The air 10 is intended to be discharged to the vehicle exterior without being fed to the vehicle-mounted air conditioning system 11. When looking at the outlet of the vehicle exterior flow path 31 along the extending direction 31E of the vehicle exterior flow path 31, if the outlet of the vehicle exterior flow path 31 completely overlaps with the intake port 110 of the vehicle-mounted air conditioning system 11, the adsorption target substances desorbed from the conditioning device 2 are introduced into the vehicle interior through the vehicle-mounted air conditioning system 11. As in the vehicle-mounted air component adjusting system 1 according to this embodiment, the outlet of the vehicle exterior flow path 31 is provided at a position displaced from the intake port 110, thereby reducing the risk that the adsorption target substances desorbed from the conditioning device 2 will be introduced into the vehicle interior through the vehicle-mounted air conditioning system 11.

The air intake 110 of the vehicle-mounted air conditioning system 11 where the outlet of the vehicle exterior flow path 31 is displaced may be an intake port for internal air of the vehicle-mounted air conditioning system 11 into which the air 10 from the vehicle interior is introduced. By displacing the outlet of the vehicle exterior flow path 31 from the intake port for internal air, the risk of the adsorption target substances desorbed from the conditioning device 2 being introduced into the vehicle interior can be more reliably reduced.

In the first embodiment illustrated in FIGS. 3 and 4, the outlet of the vehicle exterior flow path 31 is provided on the side of the intake 110 of the vehicle-mounted air conditioning system 11 and is completely displaced from the intake port 110 of the vehicle-mounted air conditioning system 11. However, even if only a portion of the outlet of the vehicle exterior flow path 31 is displaced from the intake port 110 of the vehicle-mounted air conditioning system 11, the risk of the adsorption target substances desorbed from the conditioning device 2 being introduced into the vehicle interior can be reduced as compared to a case where the outlet of the vehicle exterior flow path 31 completely overlaps with the intake port 110 of the vehicle-mounted air conditioning system 11. When the outlet of the vehicle exterior flow path 31 is viewed from the upstream side in the flow direction of the air 10 along the extending direction 31E of the vehicle exterior flow path 31, it is preferable that a ratio (A1/A0) of an area (A1) of a region that overlaps with the intake port 110 at the outlet of the vehicle exterior flow path 31 to the total area (A0) of the outlet of the vehicle exterior flow path 31 is 30% or less. The ratio (A1/A0) of 30% or less will more reliably reduce the risk that the adsorption target substances desorbed from the conditioning device 2 will be introduced into the vehicle interior. The ratio (A1/A0) is more preferably 20% or less, and even more preferably 10% or less. When the outlet of the vehicle exterior flow path 31 is completely displaced from the intake port 110 of the vehicle-mounted air conditioning system 11, as in the first embodiment illustrated in FIGS. 3 and 4, the area (A1) is 0 and the ratio (A1/A0) is 0%.

The outlet of the vehicle exterior flow path 31 is located at the end position of the vehicle exterior flow path 31 and is defined by the inner surface of the wall of the duct 3. The total area (A0) of the outlet of the vehicle exterior flow path 31 is the area of the space inside the wall of duct 3 in the plane orthogonal to the extending direction 31E of the vehicle exterior flow path 31. The intake port 110 is defined by the inner surface of the wall of the intake port frame 111. Grids may be provided at the outlet and/or at the intake port 110 of the vehicle exterior flow path 31. The presence of the grid may be ignored when calculating measurement of the total area (A0) of the outlet of the vehicle exterior flow path 31 and the area (A1) of the region that overlaps with the intake port 110 at the outlet of the vehicle exterior flow path 31. In the first embodiment illustrated in FIGS. 3 and 4, the duct 3 and the intake port frame 111 are adjacent to each other.

In the first embodiment, the vehicle interior flow path 30 extends parallel to the vehicle exterior flow path 31. When the outlet of the vehicle interior flow path 30 is viewed from the upstream side in the flow direction of the air 10 along the extending direction 30E of the vehicle interior flow path 30, the outlet of the vehicle interior flow path 30 overlaps with the intake port 110. More specifically, the outlet of the vehicle interior flow path 30 completely overlaps with the intake port 110. The area of the intake port 110 is larger than that of the outlet of the vehicle interior flow path 30, and the intake port 110 has a region that does not overlap with the outlet of the vehicle interior flow path 30. Through this non-overlapping region, the air 10 that does not pass through the vehicle-mounted air component adjusting system 1 can be fed to the vehicle-mounted air conditioning system 11.

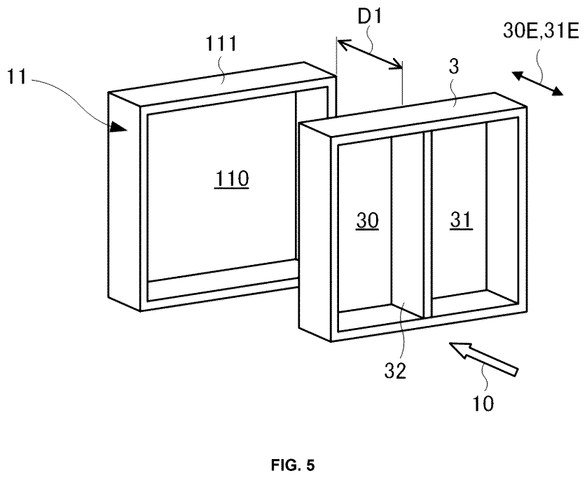

Next, FIG. 5 is a schematic perspective view illustrating a second embodiment of a positional relationship between the outlet of the vehicle exterior flow path 31 and the intake port of the vehicle-mounted air conditioning system 11 in FIG. 2. As shown in FIG. 5, the duct 3 and the intake port frame 111 may be separated from each other. In the second embodiment of FIG. 5, when the outlet of the vehicle exterior flow path 31 is viewed along the extending direction 31E of the vehicle exterior flow path 31, the positional relationship between the outlet of the vehicle exterior flow path 31 and the intake port 110 is the same as that illustrated in FIG. 4. A distance D1 between the duct 3 and the intake port frame 111 in the extending direction 31E of the vehicle exterior flow path 31 is preferably 800 mm or less. The distance D1 of 800 mm or less can reduce the risk of the air 10 from the vehicle exterior flow path 31 being sucked into the intake port 110. Other configurations are the same as those of the first embodiment.

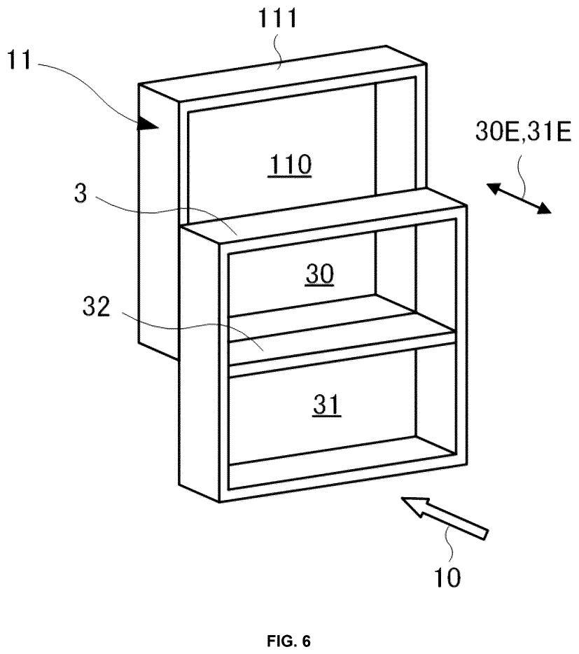

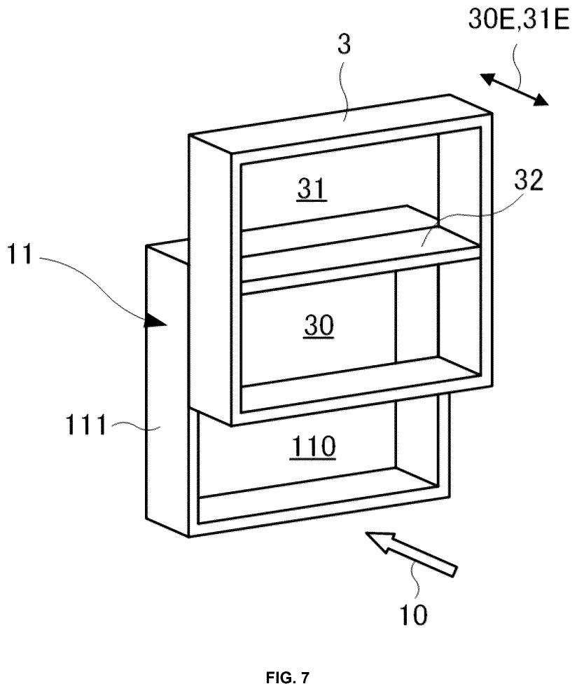

Next, FIG. 6 is a schematic perspective view illustrating a third embodiment of a positional relationship between the outlet of the vehicle exterior flow path 31 and the intake port 110 of the vehicle-mounted air conditioning system 11 in FIG. 2, and FIG. 7 is a schematic perspective view illustrating a fourth embodiment of a positional relationship between the outlet of the vehicle exterior flow path 31 and the intake port 110 of the vehicle-mounted air conditioning system 11 in FIG. 2. The outlet of the vehicle exterior flow path 31 may be provided below the intake port 110 (see FIG. 6) or above the intake port 110 (see FIG. 7). Other configurations are the same as those of the first and second embodiments.

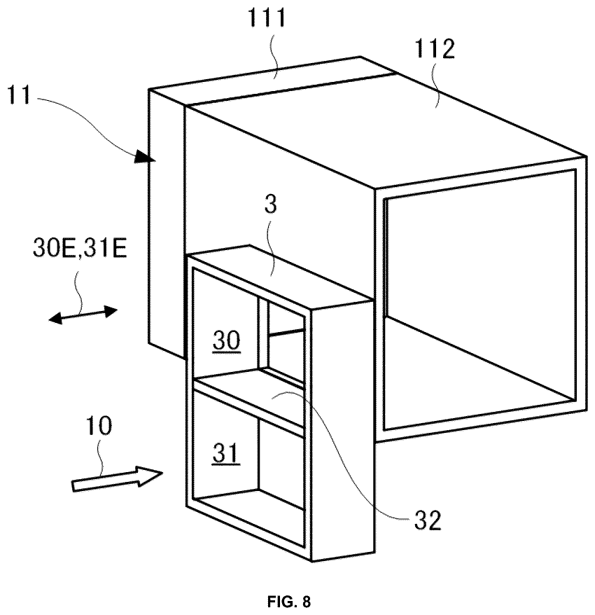

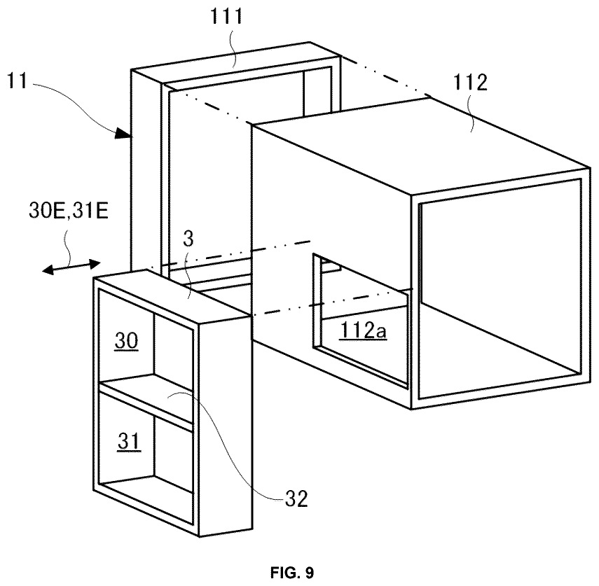

Next, FIG. 8 is a schematic perspective view illustrating a fifth embodiment of a positional relationship between the outlet of the vehicle exterior flow path 31 and the intake port 110 of the vehicle-mounted air conditioning system 11 in FIG. 2, and FIG. 9 is an exploded perspective view of the duct 3, the intake port frame 111 and the intake port duct 112 in FIG. 8. As shown in FIGS. 8 and 9, the air intake duct 112 may be attached to the air intake port frame 111, and the duct 3 may be connected to the intake port 110 via the intake port duct 112. As particularly shown in FIG. 9, the side surface of the intake port duct 112 is provided with an opening 112a, and the duct 3 is provided so that the outlet of the vehicle interior flow path 30 is adjacent to the opening 112a. Also in the fifth embodiment, when the outlet of the vehicle exterior flow path 31 is viewed along the extending direction 31E of the vehicle exterior flow path 31 from the upstream side in the flow direction of the air 10, it is understandable that the outlet of the vehicle exterior flow path 31 does not overlap with the intake port 110, and the outlet of the vehicle exterior flow path 31 is displaced from the intake port 110. Other configurations are the same as those of the first to fourth embodiments.

### (2. Regarding Conditioning Device)

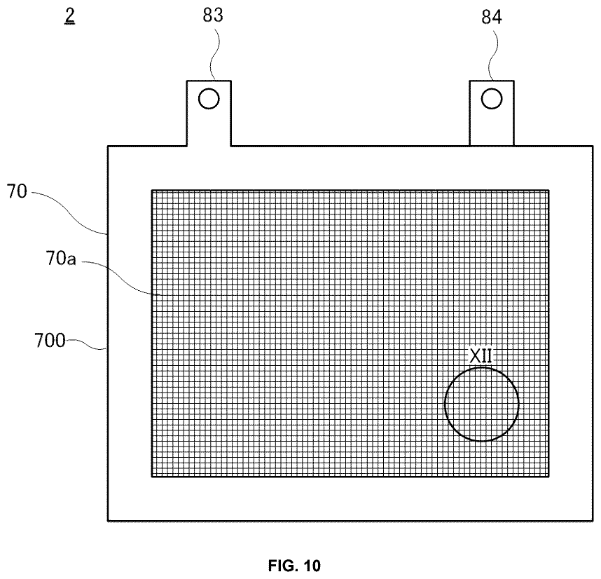

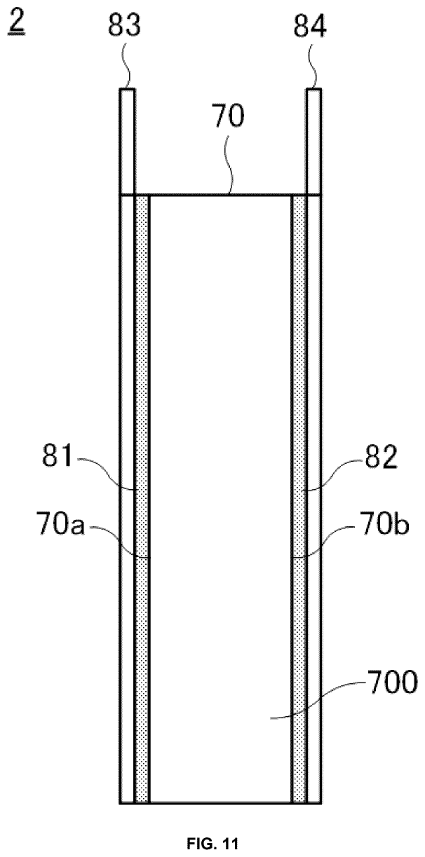

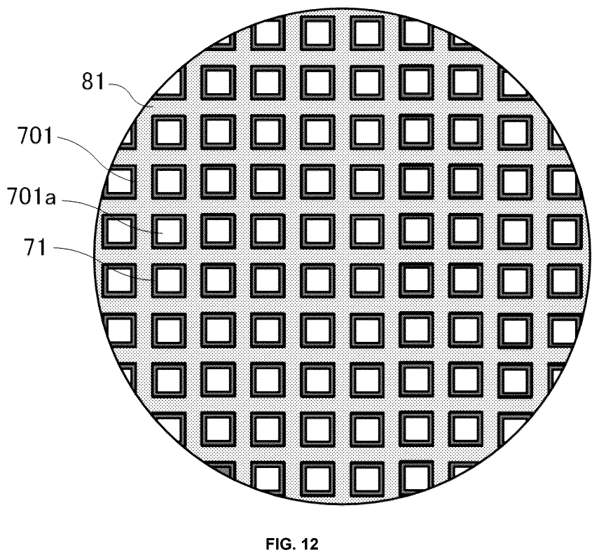

Next, FIG. 10 is a front view illustrating a first embodiment of the conditioning device 2 in FIG. 2, FIG. 11 is a right side view illustrating the conditioning device 2 in FIG. 10, and FIG. 12 is an enlarged view illustrating the region XII in FIG. 10.

As shown in FIGS. 10 to 12, the adsorption portion 20 of the conditioning device 2 according to this embodiment has a structure 70 and an adsorbing layer 71. The structure 70 includes: an outer wall 700; and partition walls 701 provided on an inner side of the outer wall 700, the partition walls 701 defining flow paths 701a for the air 10 each extending from a first end face 70a to a second end face 70b. The adsorbing layer 71 is a layer containing the adsorbent as described above, and is provided on each surface of the partition walls 701 as illustrated in FIG. 12. As the air 10 passes through the flow path 701a between the first end face 70a and the second end face 70, the moisture in the air 10 is adsorbed by the adsorbent in the adsorbing layer 71. The flow paths 701a may also be referred to as cells.

In the conditioning device 2 according to the first embodiment, the heating means 21 has a pair of electrodes 81, 82 connected to the structure 70, and heats the structure 70 by applying an electric current to the structure 70 through the pair of electrodes 81, 82. Hereinafter, when the electrodes 81, 82 are to be distinguished from each other, one will be referred to as a first electrode 81 and the other as a second electrode 82.

As particularly illustrated in FIG. 11, the first electrode 81 is provided on the first end face 70a of the structure 70, and the second electrode 82 is provided on the second end face 70b of the structure 70. The first electrode 81 and the second electrode 82 are provided on the end face of the outer wall 700, and also provided on the end face of the partition walls 701 as illustrated in FIG. 12. On the first electrode 81 and on the second electrode 82, the flow paths 701a are not plugged. However, a part of flow paths 701a may be plugged on the first electrode 81 and/or by the second electrode 82.

As shown in FIGS. 10 and 11, a first metal terminal 83 may be provided on the first electrode 81, and a second metal terminal 84 may be provided on the second electrode 82. The first metal terminal 83 and the second metal terminal 84 are formed as rectangular frames attached to the outer peripheral portions of the first end face 70a and the second end face 70b, respectively. The first metal terminal 83 and the second metal terminal 84 are provided with extending portions each extending from the rectangular frame outward in the width direction of the structure 70.

A positive electrode of a power source (not shown) is connected to one extending portion of the first metal terminal 83 and the second metal terminal 84, and a negative electrode of the power source is connected to the other extending portion of the first metal terminal 83 and the second metal terminal 84. Assuming that the positive electrode is connected to the extending portion of the first metal terminal 83 and the negative electrode is connected to the extending portion of the second metal terminal 84, the current from the first metal terminal 83 spreads over the first end face 70a through the first electrode 81, flows through the structure 70 in the extending direction of the flow paths 701a, and flows on the second end face 70b through the second electrode 82 into the second metal terminal 84. The current flows in such a manner, thereby heating the structure 70 uniformly.

The structure 70 may be a honeycomb structure in which at least the partition walls 701 are made of a material having a PTC (Positive Temperature Coefficient) property. Further, the material having the PTC property has characteristics such that when the temperature increases to exceed the Curie point, the resistance value is sharply increased, making it difficult for electricity to flow.

Hereinafter, each of the components of the first embodiment of the conditioning device 2 will be described in detail.

### (2-1. Regarding Structure)

The shape of the structure 70 (honeycomb structure) is not particularly limited. For example, an outer shape of a cross section of the structure 70 orthogonal to the flow path direction (extending direction of the flow paths 701a) can be polygonal such as quadrangular (rectangular, square), pentagonal, hexagonal, heptagonal, and octagonal, circular, oval (egg-shaped, elongated circular, elliptical, rounded rectangular, etc.), or the like. The end faces (first end face 70a and second end face 70b) have the same shape as the cross section. Also, when the cross section and the end faces are polygonal, the corners may be chamfered.

The shape of each flow path 701a is not particularly limited, but it may be polygonal such as quadrangular, pentagonal, hexagonal, heptagonal, and octagonal, circular, or oval in the cross section of the structure 70 orthogonal to the flow path direction. These shapes may be alone or in combination of two or more. Moreover, among these shapes, the quadrangle or the hexagon is preferable. By providing the flow paths 701a having such a shape, it is possible to reduce the pressure loss when the air 10 flows. In FIGS. 10 to 12, the structure 70 is illustrated as an example in which the outer shape of the cross section and the shape of each flow path 701a are quadrangular in the cross section orthogonal to the flow path direction.

The structure 70 may be a honeycomb joined body that includes a plurality of honeycomb segments and joining layers that join outer peripheral side surfaces of the plurality of honeycomb segments together. The use of the honeycomb joined body can increase the total cross-sectional area of the flow paths 701a, which is important for ensuring the flow rate of the air 10, while suppressing cracking.

It should be noted that the joining layer can be formed by using a joining material. The joining material is not particularly limited, but a ceramic material obtained by adding a solvent such as water to form a paste can be used. The joining material may contain a material having a PTC property, or may contain the same material as the outer wall 700 and the partition walls 701. In addition to the role of joining the honeycomb segments to each other, the joining material can also be used as an outer peripheral coating material after joining the honeycomb segments.

From the viewpoints of ensuring the strength of the structure 70, reducing pressure loss when the air 10 passes through the flow paths 701a, ensuring the amount of functional material supported, and ensuring the contact area with the air 10 flowing inside the flow paths 701a, it is desirable to suitably combine a thickness of the partition wall 701, a cell density, and a cell pitch (or an opening ratio of the cells).

As used herein, the cell density refers to a value obtained by dividing a number of cells by an area of one end face (first end face 70a or second end face 70b) of the structure 70 (the total area of the partition walls 701 and the flow paths 701a excluding the outer wall 700).

As used herein, the cell pitch refers to a value obtained by the following calculation. First, the area of one end face (first end face 70a or second end face 70b) of the structure 70 (the total area of the partition walls 701 and the flow paths 701a excluding the outer wall 700) is divided by the number of the cells to calculate an area per a cell. A square root of the area per a cell is then calculated, and this is determined to be the cell pitch.

As used herein, the opening ratio of the cells refers a value obtained by dividing the total area of the flow paths 701a defined by the partition walls 701 by the area of one end face (first end face 70a or second end face 70b) (the total area of the partition walls 701 and the flow paths 701a excluding the outer wall 700) in the cross section orthogonal to the flow path direction of the structure 70. In addition, when calculating the opening ratio of the flow paths 701a, the first electrode 81, the second electrode 82, and an adsorbing layer 71 as described below are not taken into consideration.

In an embodiment that is advantageous from the viewpoint of supporting a sufficient amount of functional material, the thickness of the partition walls 701 is 0.300 mm or less, the cell density is 100 cells/cm² or less, and the cell pitch is 1.0 mm or more. In a preferred embodiment, the thickness of the partition walls 701 is 0.200 mm or less, the cell density is 70 cells/cm² or less, and the cell pitch is 1.2 mm or more. In a more preferred embodiment, the thickness of the partition walls 701 is 0.130 mm or less, the cell density is 65 cells/cm² or less, and the cell pitch is 1.3 mm or more.

In each embodiment as described above, from the viewpoints of ensuring the strength of the structure 70 and maintaining lower electrical resistance, the lower limit of the thickness of the partition walls 701 is preferably 0.010 mm or more, more preferably 0.020 mm or more, and even more preferably 0.030 mm or more.

In each embodiment as described above, from the viewpoints of ensuring the strength of the structure 70, maintaining lower electrical resistance, and increasing a surface area to facilitate reaction, adsorption, and separation, the lower limit of the cell density is 30 cells/cm² or more, and preferably 35 cells/cm² or more, and even more preferably 40 cells/cm² or more.

In each embodiment as described above, from the viewpoints of ensuring the strength of the structure 70, maintaining lower electrical resistance and increasing a surface area to facilitate reaction, adsorption and release, the upper limit of the cell pitch is 2.0 mm or less, and more preferably 1.8 mm or less, and even more preferably 1.6 mm or less.

In an embodiment that is advantageous in terms of both reducing pressure loss and maintaining strength, the thickness of the partition walls 701 is 0.08 to 0.36 mm, the cell density is 2.54 to 140 cells/cm², and the opening ratio of the flow paths 701a is 0.70 or more. In a preferred embodiment, the thickness of the partition walls 701 is 0.09 to 0.35 mm, the cell density is 15 to 100 cells/cm², and the opening ratio of the flow paths 701a is 0.80 or more. In a more preferred embodiment, the thickness of the partition walls 701 is 0.14 to 0.30 mm, the cell density is 20 to 90 cells/cm², and the opening ratio of the flow paths 701a is 0.85 or more.

In each embodiment as described above, from the viewpoint of ensuring the strength of the structure 70, the upper limit of the opening ratio of the flow paths 701a is preferably 0.94 or less, more preferably 0.92 or less, and even more preferably 0.90 or less.

Although the thickness of the outer wall 700 is not particularly limited, it is preferably determined based on the following considerations. First, from the viewpoint of reinforcing the structure 70, the thickness of the outer wall 700 is preferably 0.05 mm or more, more preferably 0.06 mm or more, and even more preferably 0.08 mm or more. On the other hand, when the viewpoint of suppressing the initial current by increasing the electrical resistance and from the viewpoint of reducing pressure loss when air flows are considered, the thickness of the outer wall 700 is preferably 1.0 mm or less, more preferably 0.5 mm, even more preferably 0.4 mm or less, and still more preferably 0.3 mm or less.

As used herein, the thickness of the outer wall 700 refers to a length from a boundary between the outer wall 700 and the outermost flow path 701a or the partition wall 701 to a side surface of the structure 70 in a normal line direction of the side surface in the cross section orthogonal to the flow path direction.

The length of the structure 70 in the flow path direction and the cross-sectional area orthogonal to the flow path direction may be adjusted according to the required size of the conditioning device 2, and are not particularly limited. For example, when used in a compact conditioning device 2 while ensuring a predetermined function, the structure 70 can have a length of 2 to 20 mm in the flow path direction and have a cross-sectional area of 10 cm² or more orthogonal to the flow path direction. Although the upper limit of the cross-sectional area orthogonal to the flow path direction is not particularly limited, it is, for example, 300 cm².

The partition walls 701 forming the structure 70 are made of a material that can be heated by electric conduction, specifically made of a material having the PTC property. Further, the outer wall 700 may also be made of a material having a PTC property, as with the partition walls 701, as needed. By such a configuration, the adsorbing layer 71 can be directly heated by heat transfer from the heat-generating partition walls 701 (and optionally the outer wall 700). Further, the material having the PTC property has characteristics such that when the temperature increases to exceed the Curie point, the resistance value is sharply increased, making it difficult for electricity to flow. Therefore, when the temperature of the conditioning device 2 becomes high, the partition walls 701 (and the outer wall 700 if necessary) have limited current flowing through them, thereby suppressing excessive heat generation of the conditioning device 2. Therefore, it is possible to suppress thermal deterioration of the adsorbing layer 71 due to excessive heat generation.

From the viewpoint of obtaining appropriate heat generation, the lower limit of the volume resistivity at 25° C. of the material having the PTC property is preferably 0.5 Ω·cm or more, and more preferably 1 Ω·cm or more, and even more preferably 5 Ω·cm or more. From the viewpoint of generating heat with a low driving voltage, the upper limit of the volume resistivity at 25° C. of the material having the PTC property is preferably 30 Ω·cm or less, and more preferably 18 Ω·cm or less, and even more preferably 16 Ω·cm or less. As used herein, the volume resistivity at 25° C. of the material having the PTC property is measured according to JIS K 6271:2008.

From the viewpoints of creating a device that can be heated by electric conduction and have the PTC property, the outer wall 700 and the partition walls 701 are preferably made of a material containing barium titanate (BaTiO₃) as a main component. Also, this material is more preferably ceramics made of a material containing barium titanate (BaTiO₃)-based crystals as a main component in which a part of Ba is substituted with a rare earth element. As used herein, the term “main component” means a component in which a proportion of the component is more than 50% by mass of the total component. The content of BaTiO₃-based crystalline particles can be determined by fluorescent X-ray analysis. Other crystalline particles can be measured in the same manner as this method.

The compositional formula of BaTiO₃-based crystalline particles, in which a part of Ba is substituted with the rare earth element, can be expressed as (Ba₁₋ₓAₓ)TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering.

The content of the BaTiO₃-based crystalline particles in which a part of Ba is substituted with the rare earth element in the ceramics is not particularly limited as long as it is determined to be the main component. However, it may preferably be 90% by mass or more, and more preferably 92% by mass or more, and even more preferably 94% by mass or more. The upper limit of the content of the BaTiO₃-based crystalline particles is not particularly limited, but it may generally be 99% by mass, and preferably 98% by mass.

The content of the BaTiO₃-based crystalline particles can be measured by fluorescent X-ray analysis. Other crystalline particles can be measured in the same manner as this method.

In terms of reduction of the environmental load, it is desirable that the materials used for the outer wall 700 and the partition walls 701 are substantially free of lead (Pb). Specifically, the outer wall 700 and the partition walls 701 preferably have a Pb content of 0.01% by mass or less, and more preferably 0.001% by mass or less, and still more preferably 0% by mass. The lower Pb content can allow the air 10 heated by contact with the heat-generating partition walls 701 to be safely applied to organisms such as humans, for example. In the outer wall 700 and the partition walls 701, the Pb content is preferably less than 0.03% by mass, more preferably less than 0.01% by mass, and even more preferably 0% by mass, as converted to PbO. The lead content can be determined by ICP-MS (inductively coupled plasma mass spectrometry).

In terms of efficiently heating the air, the material making up the outer wall 700 and the partition walls 701 preferably have a lower limit of a Curie point of 80° C. or more, more preferably 80° C. or more, and even more preferably 100° C. or more. Further, in terms of safety as a component placed in the vehicle interior or near the vehicle interior, the upper limit of the Curie point is preferably 250° C. or more, more preferably 225° C. or more, even more preferably 200° C. or more, and still more preferably 150° C. or more.

The Curie point of the material making up the outer wall 700 and the partition walls 701 can be adjusted by the type and amount of shifter added. For example, the Curie point of barium titanate (BaTIO₃) is about 120° C., but the Curie point can be shifted to the lower temperature side by substituting a part of Ba and Ti with one or more of Sr, Sn and Zr.

As used herein, the Curie point is measured by the following method. A sample is attached to a sample holder for measurement, mounted in a measuring tank (e.g., MINI-SUBZERO MC-810P, from ESPEC), and a change in electrical resistance of the sample as a function of a temperature change when the temperature is increased from 10° C. is measured using a DC resistance meter (e.g., Multimeter 3478A, from YOKOGAWA HEWLETT PACKARD, LTD.). Based on an electrical resistance-temperature plot obtained by the measurement, a temperature at which the resistance value is twice the resistance value at room temperature (20° C.) is defined as the Curie point.

### (2-2. First Electrode and Second Electrode)

The first electrode 81 and the second electrode 82 are provided on the first end face 70a and the second end face 70b, respectively. Applying a voltage between the first electrode 81 and the second electrode 82 allows the structure 70 to generate heat by Joule heat.

The first electrode 81 and the second electrode 82 may employ, for example, a metal or alloy containing at least one selected from Cu, Ag, Al, Ni and Si, although not particularly limited thereto. It is also possible to use an ohmic electrode capable of ohmic contact with the outer wall 700 and/or the partition walls 701 which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the first electrode 81 and the second electrode 82 may have a single-layer structure, or may have a laminated structure of two or more layers. When the first electrode 81 and the second electrode 82 have the laminated structure of two or more layers, the materials of the respective layers may be of the same type or of different types.

The thicknesses of the first electrode 81 and the second electrode 82 may be appropriately set according to the method for forming the first electrode 81 and the second electrode 82. The method for forming the first electrode 81 and the second electrode 82 includes metal deposition methods such as sputtering, vapor deposition, electrolytic deposition, and chemical deposition. Alternatively, the first electrode 81 and the second electrode 82 can be formed by applying an electrode paste and then baking it, or by thermal spraying. Furthermore, the first electrode 81 and the second electrode 82 may be formed by joining metal sheets or alloy sheets.

Each thickness of the first electrode 81 and the second electrode 82 is, for example, about 5 to 30 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition. Further, when joining the metal sheet or alloy sheet, each thickness is preferably about 5 to 100 μm.

### (2-3. First Metal Terminal and Second Metal Terminal)

The provision of the first metal terminal 83 and the second metal terminal 84 facilitates connection to an external power source. The first metal terminal 83 and the second metal terminal 84 are connected to a conductor connected to the external power source.

The metal that makes up the first metal terminal 83 and the second metal terminal 84 may include single metals, alloys, and the like, but from the viewpoint of corrosion resistance, electrical resistivity, and coefficient of linear expansion, it may preferably be alloys containing at least one selected from the group consisting of Cr, Fe, Co, Ni, Cu, Al, and Ti, and more preferably stainless steel, Fe—Ni alloy, and phosphor bronze. Furthermore, the thickness of each of the first metal terminal 83 and the second metal terminal 84 is not particularly limited, but it is, for example, 0.01 to 10 mm, typically 0.05 to 5 mm.

The method of connecting the first metal terminal 83 and the second metal terminal 84 to the first electrode 81 and the second electrode 82, respectively, is not particularly limited as long as they are electrically connected. For example, they can be connected by diffusion bonding, a mechanical pressing mechanism, welding, or the like.

### (2-4. Intermediate Material)

Intermediate materials may be provided between: the first electrode 81 and the second electrode 82; and the first metal terminal 83 and the second metal terminal 84. The provision of the intermediate materials results in high structural freedom of the connection between the first electrode 81 and the second electrode 82 and the first metal terminal 83 and the second metal terminal 84. The intermediate material may be made of non-limiting materials, and it may be the same as the material of the first metal terminal 83 and the second metal terminal 84 as described above. Moreover, the material of the intermediate material may be different from that of the first metal terminal 83 and the second metal terminal 84 as described above. In this case, the intermediate material can be made of a solder, a brazing material, a conductive adhesive, or the like. The method of connecting the intermediate materials to the first metal terminal 83 and the second metal terminal 84 and the first electrode 81 and the second electrode 82 is not particularly limited as long as they are electrically connected. For example, they can be connected by diffusion bonding, a mechanical pressing mechanism, welding, or the like.

### (2-5. Adsorbing Layer)

As illustrated in FIG. 12, the conditioning device 2 may be provided with an adsorbing layer 71 on each surface of the partition walls 701. The adsorbing layer 71 can be provided on the surfaces of the partition walls 701 (in the case of the outermost flow path 701a, the partition walls 701 that define the outermost flow path 701a and the outer wall 700). By thus providing the adsorbing layer 71, the functional material contained in the adsorbing layer 71 can be easily heated, so that the desired function due to the functional material can be exerted.

The adsorbent contained in the adsorbing layer 71 is not particularly limited as long as it can exhibit the desired function. The adsorbent has a function of adsorbing moisture, carbon dioxide and/or volatile components in the air. The adsorbing layer 71 may further contain a catalyst. This can allow the adsorption target substances to be purified. By using the adsorbent in combination with the catalyst, the function of the adsorbent to capture the adsorption target substances can be improved.

The adsorbent preferably has a function that can adsorb the adsorption target substances, for example, moisture, carbon dioxide and volatile components, etc., at −20 to 40° C. and desorb them at an elevated temperature of 60° C. or more. Examples of the adsorbent having such a function include zeolite, silica gel, activated carbon, alumina, silica, low-crystalline clay, amorphous aluminum silicate complexes, and the like. The type of the adsorbent may be appropriately selected depending on the types of the adsorption target substances. The adsorbent may be used alone, or in combination with two or more types.

The catalyst preferably has a function capable of promoting the oxidation-reduction reaction. The catalyst having such a function includes metal catalysts such as Pt, Pd and Ag, and oxide catalysts such as CeO₂ and ZrO₂. The catalyst may be used alone or in combination of two or more types.

The volatile components contained in the air in the vehicle interior are, for example, volatile organic compounds (VOCs) and odor components other than the VOCs. Specific examples of the volatile components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, 2-(1-methylpropyl)phenyl N-methylcarbamate, and the like.

The thickness of the adsorbing layer 71 may be determined according to the size of the flow path 701a, and is not particularly limited. For example, from the viewpoint of ensuring sufficient contact with the air 10, the thickness of the adsorbing layer 71 is preferably 20 μm or more, more preferably 25 μm or more, and even more preferably 30 μm or more. On the other hand, from the viewpoint of suppressing separation of the adsorbing layer 71 from the partition walls 701 and the outer wall 700, the thickness of the adsorbing layer 71 is preferably 400 μm or less, more preferably 380 μm or less, and even more preferably 350 μm or less.

The thickness of the adsorbing layer 71 is measured using the following procedure. Any cross section of the structure 70 parallel to the flow path direction is cut out, and a cross-sectional image at magnifications of about 50 is acquired using a scanning electron microscope or the like. Also, this cross section is made to pass through the center of gravity position in the cross section orthogonal to the flow path of the structure 70. The thickness of each adsorbing layer 71 visually recognized from the cross-sectional image is calculated by dividing the cross-sectional area by the length of the flow paths 701a in the flow path direction. This calculation is performed for all the adsorbing layers 71 visually recognized from the cross-sectional image, and an average value thereof is determined to be the thickness of the adsorbing layer 71.

From the viewpoint of exerting a desired function in the conditioning device 2, an amount of the adsorbing layer 71 is preferably 50 to 500 g/L, more preferably 100 to 400 g/L, and even more preferably 150 to 350 g/L, based on the volume of the structure 70. It should be noted that the volume of the structure 70 is a value determined by the external dimensions of the structure 70.

### (3. Method for Producing Conditioning Device)

The method for producing the conditioning device according to an embodiment of the invention is not particularly limited as long as it is a method having the characteristics as described above, and can be carried out in accordance with a known method. Hereinafter, the method for producing the conditioning device according to an embodiment of the invention will be specifically described.

A method for producing the honeycomb structure forming the conditioning device includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them together. The green body may optionally contain additives such as shifters, metal oxides, property improving agents, and conductor powder.

The blending amount of the components other than the ceramic raw material is not particularly limited as long as the relative density of the honeycomb formed body is 60% or more.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extruding the green body. For the extrusion, a die having a desired overall shape, cell shape, partition wall thickness, cell density and the like can be used.

The relative density of the honeycomb formed body obtained by extrusion is 60% or more, and preferably 65% or more. By limiting the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include known drying methods such as hot air drying, microwave drying, dielectric drying, drying under reduced pressure, drying in vacuum, and freeze drying. Among these, a drying method that combines the hot air drying with the microwave drying or dielectric drying is preferable because the entire formed body can be rapidly and uniformly dried.

The firing step includes maintaining the formed body at a temperature of from 1150 to 1250° C., and then increasing the temperature to a maximum temperature of from 1360 to 1430° C. at a heating rate of 20 to 600° C./hour, and maintaining the temperature for 0.5 to 10 hours.

The maintaining of the honeycomb formed body at the maximum temperature of from 1360 to 1430° C. for 0.5 to 10 hours can provide the structure 70 containing, as a main component, BaTiO₃-based crystal particles in which a part of Ba is substituted with the rare earth element.

Further, maintaining the temperature of the honeycomb formed body of 1150 to 1250° C. can allow the Ba₂TiO₄ crystal particles generated in the firing process to be easily removed, so that the structure 70 can be densified.

Further, the heating rate of 20 to 600° C./hour from the temperature of 1150 to 1250° C. to the maximum temperature of 1360 to 1430° C. can allow 1.0 to 10.0% by mass of Ba₆Ti₁₇O₄₀ crystal particles to be formed into the structure 70.

The amount of time when the honeycomb formed body is maintained at 1150 to 1250° C. is not particularly limited, but it may preferably be from 0.5 to 10 hours. Such a maintaining time can lead to stable and easy removal of Ba₂TiO₄ crystal particles generated in the firing process.

The firing step preferably includes maintaining the honeycomb formed body at 900 to 950° C. for 0.5 to 5 hours while the temperature is increased. Maintaining the honeycomb formed body at 900 to 950° C. for 0.5 to 5 hours can lead to sufficient decomposition of BaCO₃, so that a structure 70 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost.

A firing furnace used in the firing step and the degreasing step is not particularly limited, but it may be an electric furnace, a gas furnace, or the like.

The first electrode 81 and the second electrode 82 are formed on the structure 70 thus obtained, whereby the conditioning device 2 can be produced. The first electrode 81 and the second electrode 82 can also be formed by metal deposition methods such as sputtering, vapor deposition, electrolytic deposition, and chemical deposition. Further, the first electrode 81 and the second electrode 82 can also be formed by applying an electrode paste and then baking it. Furthermore, the first electrode 81 and the second electrode 82 can also be formed by thermal spraying. The first electrode 81 and the second electrode 82 may be composed of a single layer, but may also be composed of a plurality of electrode layers having different compositions. A typical method for forming the first electrode 81 and the second electrode 82 will be described below.

First, an electrode slurry containing an electrode material, an organic binder, and a dispersion medium is prepared, and the first end face 70a or the second end face 70b of the structure 70 is coated with the slurry. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. An excess slurry on the periphery of the structure 70 is removed by blowing and wiping. The slurry can be then dried to form the first electrode 81 and the second electrode 82 on the first end face 70a or the second end face 70b of the structure 70. The drying can be performed while heating the conditioning device to a temperature of about 120 to 600° C., for example. Although a series of steps of coating, slurry removal, and drying may be performed only once, the steps can be repeated multiple times to provide the first electrode 81 and the second electrode 82 having desired thicknesses.

The first metal terminal 83 and the second metal terminal 84 are then placed at predetermined positions of the first electrode 81 and the second electrode 82, respectively, and the first electrode 81 and the second electrode 82 are connected to the first metal terminal 83 and the second metal terminal 84, respectively. As a method of connecting the first electrode 81 and the second electrode 82 to the terminals, the method described above can be used. Further, when the intermediate materials are provided between: the first electrode 81 and the second electrode 82; and the first metal terminal 83 and the second metal terminal 84, the intermediate material can be placed at a predetermined position of the first electrode 81 and the second electrode 82 and connected to each other, and then the first metal terminal 83 and the second metal terminal 84 can be placed at a predetermined position of the intermediate material and connected to each other. As a method for connecting these, the method as described above can be used. It should be noted that the first metal terminal 83, the second metal terminal 84 and the intermediate material may be provided after the adsorbing layer 71 described below is formed.

The adsorbing layer 71 is then formed on each surface of the partition walls 701 and the like of the conditioning device 2 thus obtained, thereby obtaining a conditioning device with functional material-containing layers.

Although the method for forming the adsorbing layer 71 is not particularly limited, it can be formed, for example, by the following steps. The conditioning device 2 is immersed in a slurry containing a functional material, an organic binder, and a dispersion medium for a predetermined period of time, and an excess slurry on the end faces and the outer periphery of the structure 70 is removed by blowing and wiping. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. The slurry can be then dried to form the adsorbing layer 71 on the surfaces of the partition walls 701. The drying can be performed while heating the conditioning device 2 to a temperature of about 120 to 600° C., for example. Although a series of steps of immersion, slurry removal, and drying may be performed only once, the steps can be repeated multiple times to provide the adsorbing layer 71 having the desired thickness on the surfaces of the partition walls 701 and the like.

### (4. Regarding Second Embodiment of Conditioning Device)

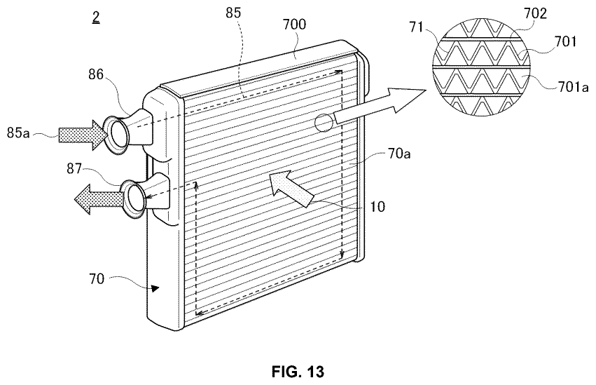

Now, FIG. 13 is a perspective view of a second embodiment of the conditioning device in FIG. 2. In the first embodiment of the conditioning device 2 illustrated in FIGS. 10 to 12, a honeycomb structure as the structure 70 was heated by electrical conduction. However, the structure 70 may be heated by other methods. In the second embodiment of the conditioning device 2 illustrated in FIG. 13, the heating means 21 has a pipe 85 provided inside the structure 70, and the structure 70 is heated by allowing a heated medium 85a to flow through the pipe 85.

The pipe 85 may be passed through the interior of the honeycomb structure described above, but a structure such as a so-called radiator may also be used as the structure 70. In the second embodiment of the conditioning device 2 illustrated in FIG. 13, the structure 70 includes: an outer wall 700; a plurality of intermediate walls 702 provided on an inner side of the outer wall 700; and fin bodies as the partition walls 701 each provided between the outer wall 700 and the intermediate wall 702 and between the intermediate walls 702. The fin bodies define flow paths 701a for the air 10 each extending from the first end face 70a to the second end face (the back surface in the figure). The adsorbing layer 71 is provided on each surface of the fin bodies as the partition walls 701.

The outer wall 70 is provided with an introduction port 86 and a discharge port 87, and the pipe 85 extends between the introduction port 86 and the discharge port 87. The medium 85a from the introduction port 86 passes through the pipe 85 and is discharged from the discharge port 87. Although the pipe 85 is depicted in a simplified manner in FIG. 13, the pipe 85 is actually bent and/or branched so as to extend throughout the entire structure 70. Other configurations are the same as the first embodiment of the conditioning device 2.

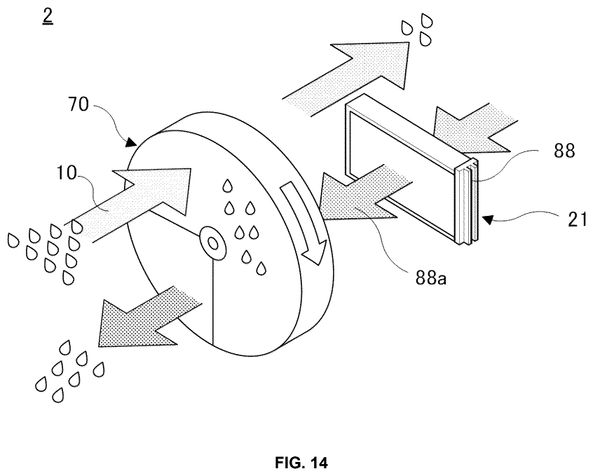

Now, FIG. 14 is a perspective view of a third embodiment of the conditioning device 2 in FIG. 2. In the third embodiment of the conditioning device 2 illustrated in FIG. 14, the heating means 21 has a heater 88 that feeds a heated air 88a to the structure 70, and heats the structure 70 by passing the heated air 88a through the structure 70.

Such a heating means 21 may be used in combination with the fixed structure 70, but it may also be used in combination with a rotatably provided structure 70 as illustrated in FIG. 14. Specifically, the honeycomb structure as the structure 70 may be provided rotatably around a rotational axis extending along the central axis of the honeycomb structure. At this time, the air 10 into which moisture is adsorbed may be fed to a partial region (e.g., ¼ region) of the end face of the structure 70 (honeycomb structure), and the heated air 88a may be fed to the other region (e.g., other ¼ region) of the end face of the structure 70. A portion of the structure 70 that has absorbed the moisture from the air 10 moves to a position where it receives the feed of the heated air 88a by rotation of the structure 70. This allows the moisture to be adsorbed in one portion of the structure 70 while at the same time desorbing the moisture from the other portion. The heated air 88a may flow in the same direction as the air 10, but in FIG. 13 it flows in the opposite direction to the air 10. This allows the piping layout to be simplified. The other configurations are the same as those of the conditioning device 2 according to the first and second embodiments.

While the preferred embodiments of the invention have been described above in detail with reference to the drawings, the present invention is not limited to such embodiments. It is obvious that a person skilled in the art to which this invention belongs can arrive at various variations or modifications in the scope of the technical idea recited in the claims, and it is understood that they also belong to the technical scope of this invention.

### EXAMPLES

The invention will be more specifically described by means of the following Examples. The invention is not limited to these examples.

As ceramic raw materials were prepared BaCO₃ powder, TiO₂ powder, and La(NH₃)₃·6H₂O powder. These powders were weighed to have the required composition after firing, and dry-mixed to obtain a mixed powder. The dry mixing was performed for 30 minutes. To 100 parts by mass of the resulting mixed powder were then added water, a binder, a plasticizer, and a dispersant by an appropriate amount in the range of 3 to 30 parts by mass in total so as to obtain a ceramic formed body having a relative density of 64.8% after extrusion, and then kneaded to obtain a green body. Methylcellulose was used as the binder. Polyoxyalkylene alkyl ethers were used as the plasticizer and the dispersant.

The resulting green body was then fed into an extrusion molding machine and extruded using a predetermined die to form a honeycomb structure having the shape illustrated below after firing.
Shape of cross section and end face of honeycomb structure orthogonal to flow path direction: quadrangular;
Dimensions of honeycomb structure: horizontal width of 114 mm, vertical width of 114 mm, length of 10 mm;
Shape of cross section of cells orthogonal to flow path direction: quadrangular;
Thickness of partition walls: 0.127 mm;
Thickness of outer peripheral wall: 0.8 mm;
Cell density: 85.3 cells/cm²;
Cell pitch: 1.08 mm;
Opening Ratio of Cells: 0.55 to 0.80;
Cross-sectional area of honeycomb structure orthogonal to extending direction of flow path: 13000 mm²;
Length of honeycomb structure in extending direction of flow path: 10 mm;
Volume resistivity of materials making up partition walls (and outer peripheral wall) at 25° C.: 12 Ω·cm; and
Curie point of material making up partition walls (and outer peripheral wall): 120° C.

The volume resistivity of the partition walls was controlled by adjusting the mixing ratio of the raw materials and firing conditions.

Subsequently, the resulting honeycomb structure was subjected to dielectric drying and hot air drying, and then degreased (450° C. for 4 hours) in a sintering furnace in an air atmosphere, and then sintered in an air atmosphere. The firing was performed by maintaining the honeycomb structure at a temperature of 950° C. for 1 hour, then increasing the temperature to 1200° C. and maintaining it at 1200° C. for 1 hour, and then increasing the temperature to 1400° C. (maximum temperature) at a rate of 200° C./hour and maintaining it at a temperature of 1400° C. for 2 hours.

The first electrode and the second electrode each having a thickness of 0.05 mm were formed on both end faces (first end face and second end face) of the resulting honeycomb structure, respectively. The first electrode and the second electrode were formed as follows: First, an electrode slurry containing aluminum (electrode material), ethyl cellulose and diethylene glycol monobutyl ether (organic binder) was prepared and applied to the first end face. Subsequently, an excess electrode slurry on the outer periphery of the honeycomb structure was removed by blowing and wiping, and the electrode slurry was then dried to form an electrode on one end face. Similarly, an electrode was formed on the other end face.

The honeycomb structure with the first electrode and the second electrode formed was then immersed in a slurry containing zeolite (adsorbent) as a functional material, an organic binder, and water, and the slurry adhering to excess positions (such as the outer periphery) was removed by blowing and wiping, and then dried at about 550° C. to form a functional material-containing layer at the predetermined position.

Subsequently, the first metal terminal was joined onto the first electrode and the second metal terminal was joined onto the second electrode. The first metal terminal and the second metal terminal were joined as follows: Each of the first metal terminal and the second metal terminal used was a strip-shaped metal body made of SUS430 and having a width of 3.5 mm and a thickness of 0.7 mm. The overall outer shape of the first metal terminal and the second metal terminal was a rectangular frame shape. The first metal terminal and the second metal terminal were joined by soldering onto the first electrode and the second electrode, respectively, while aligning the outer edges of the first metal terminal and the second metal terminal with the outer edges of both end faces of the honeycomb structure, respectively.

A sample of the conditioning device obtained as described above was placed inside the duct as illustrated in FIG. 2. The dimensions of each portion of the duct were as follows:
Inner dimensions of the duct at a position upstream of the branching position of the vehicle interior flow path and the vehicle exterior flow path: horizontal width 114 mm, vertical width 114 mm, length 200 mm;
Position of the vehicle interior flow path: side of the vehicle exterior flow path;
Internal dimensions of the vehicle interior flow path: horizontal width 114 mm, vertical width 50 mm, length 100 mm;
Internal dimensions of the vehicle exterior flow path: horizontal width 114 mm, vertical width 50 mm, length 100 mm;
Distance from the downstream end face of the conditioning device to the branching position of the vehicle interior flow path and the vehicle exterior flow path: 90 mm.

Further, the ends of the vehicle interior flow path and the vehicle exterior flow path of the duct were provided adjacent to the intake port of the vehicle-mounted air conditioning system, as illustrated in FIG. 3. The dimensions of the intake port were as follows:
Internal dimensions of the intake port: horizontal width 114 mm, vertical width 114 mm.

The following evaluation was then performed while changing the ratio (A1/A0) of the area (A1) of the region overlapping with the intake port at the outlet to the total area (A0) of the outlet of the vehicle exterior flow path when viewed from the upstream side in the flow direction of the air along the extending direction of the vehicle exterior flow path, as shown in Table 1 below, by relatively displacing the intake port and the duct of the vehicle-mounted air conditioning system in the left-right direction.

### (Dehumidifying Performance)

The conditioning system was subjected to the moisture adsorption mode, followed by the regeneration mode. The moisture adsorption mode was performed by starting the ventilation fan provided on the upstream side of the conditioning device without applying voltage to the conditioning device and allowing the air at a temperature of 25° C. and at relative humidity of 30% to flow at a flow rate of 0.8 m/s into the duct for 3 minutes. The regeneration mode was performing by applying a voltage of 12 V from a DC power source device to the conditioning device for 3 minutes while allowing the air under the same conditions to flow through the duct at a flow rate of 0.07 m³/min. During the regeneration mode, the ventilation fan installed outside the duct was started to send the air at a temperature of 25° C. and at a relative humidity of 30% from the outside of the duct into the intake port so that the total flow rate of the air flowing into the intake port was 1 m³/min. The flow rate of the air from the outside of the duct was changed according to the ratio (A1/A0). The relative humidity was then measured with a hygrometer installed on the downstream side of the intake port during the regeneration mode.

In Table 1 below, the relative humidity (outlet relative humidity) measured by the hygrometer of less than 40% is expressed as “circle”, and the relative humidity of 40% or more is expressed as “x”. If the relative humidity is less than 40%, the window fogging can be suppressed and the sample passes the test.

TABLE 1

| A1/A0 | Outlet Relative Humidity | Judgment |
|---|---|---|
| 0% | 30% | ∘ |
| 20% | 35% | ∘ |
| 30% | 38% | ∘ |
| 40% | 42% | x |

As shown in Table 1, the judgment was “x” when the ratio (A1/A0) was 40%. This would be because the outlet of the vehicle exterior flow path significantly overlapped with the intake port, thereby causing a large amount of the air from the vehicle exterior flow path to flow into the intake port. On the other hand, the judgment was “0” when the ratio (A1/A0) was less than or equal to 30%. The results confirm that the ratio (A1/A0) is preferably 30%. It should be noted that even if the ratio (A1/A0) is 40% or more, it may still be practical in some implementation situations.

### DESCRIPTION OF REFERENCE NUMERALS

1: vehicle-mounted air component adjusting system
2: conditioning device
3: duct
10: air
11: vehicle-mounted air conditioning system
20: adsorption portion
21: heating means
30: vehicle interior flow path
30E: extending direction
31: vehicle exterior flow path
31E: extending direction
70: structure
70a: first end face
70b: second end face
71: adsorbing layer
81: electrode
82: electrode
85: pipe
85a: medium
88: heater
88a: heated air
110: intake port
700: outer wall
701: partition wall
701a: flow path

1. A vehicle-mounted air component adjusting system provided on an upstream side of a vehicle-mounted air conditioning system in a flow direction of air from a vehicle interior or a vehicle exterior to adjust components of the air,
wherein the vehicle-mounted air component adjusting system comprises:
a conditioning device having an adsorption portion containing an adsorbent configured to adsorb at least one adsorption target substance at a temperature lower than or equal to a predetermined temperature and to desorb the adsorbed adsorption target substance when the temperature exceeds the predetermined temperature, and a heating means configured to heat the adsorption portion;
a duct comprising the conditioning device therein and allowing the air to flow therethrough, the duct having a vehicle interior flow path for introducing the air that has passed through the conditioning device into the vehicle interior, and a vehicle exterior flow path for discharging the air that has passed through the conditioning device to the vehicle exterior, and
wherein, when an outlet of the vehicle exterior flow path is viewed along an extending direction of the vehicle exterior flow path from an upstream side in a flow direction of the air, the outlet of the vehicle exterior flow path is provided at a position displaced from an intake port for the vehicle-mounted air conditioning system.

2. The vehicle-mounted air component adjusting system according to claim 1, wherein the intake port is an intake port for an interior air of the vehicle-mounted air conditioning system into which the air from the vehicle interior is introduced.

3. The vehicle-mounted air composition adjusting system according to claim 1, wherein, when the outlet of the vehicle exterior flow path is viewed along the extending direction of the vehicle exterior flow path from the upstream side in the flow direction of the air, a ratio (A1/A0) of an area (A1) of a region that overlaps with the intake port at the outlet to a total area (A0) of the outlet is 30% or less.

4. The vehicle-mounted air composition adjusting system according to claim 1, wherein the adsorption portion comprises:
a structure having an outer wall and partition walls provided on an inner side of the outer wall, the partition walls defining flow paths for the air, each of the flow paths extending from a first end face to a second end face of the structure; and
an adsorbing layer containing the adsorbent, the adsorbing layer being provided on a surface of each of the partition walls.

5. The vehicle-mounted air component adjusting system according to claim 4, wherein the heating means has a pair of electrodes connected to the structure, and the structure is heated by applying an electric current through the pair of electrodes.

6. The vehicle-mounted air component adjusting system according to claim 5, wherein at least the partition walls of the structure are made of a material having a positive temperature coefficient (PTC) property.

7. The vehicle-mounted air component adjusting system according to claim 4, wherein the heating means has a pipe provided inside the structure, and the structure is heated by a heated medium flowing through the pipe.

8. The vehicle-mounted air component adjusting system according to claim 4, wherein the heating means has a heater for feeding heated air to the structure, and the structure is heated by allowing the heated air to flow through the structure.
